(19) United States
(12) Patent Application Publication
(10) Pub. No.: US 2016/0140967 A1
(43) Pub. Date: May 19, 2016

(54) METHOD PERFORMED BY AN APPLICATION FOR COMMUNICATION WITH A USER INSTALLED AT A MOBILE TERMINAL AND A MOBILE TERMINAL FOR COMMUNICATING WITH A USER

(71) Applicant: Project Maha Inc., Dearborn, MI (US)

(72) Inventor: Antonio Kim, Gyeonggi-do (KR)

(21) Appl. No.: 14/546,811

(22) Filed: Nov. 18, 2014

(51) Int. Cl. G10L 17/22; H04R 1/08

(52) U.S. Cl. CPC G10L 17/22; H04R 1/08

(57) ABSTRACT

Disclosed are a method performed by an application for communication with a user and a mobile terminal for communicating with a user. The method performed by the application for communication with the user installed at the mobile terminal, the method comprising: outputting, via an output unit of the mobile terminal, one or more questions based on a predetermined psychology algorithm; receiving, via a mic of the mobile terminal, one or more verbal answers to the questions from the user; analyzing information related to the verbal answers using the predetermined psychology algorithm; editing a response pattern using the analysis result of the information related to the verbal answers; and outputting, via the output unit of the mobile terminal, if a verbal request of the user is received through the mic of the mobile terminal, one or more responses to the verbal request using the edited response pattern.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present disclosure relates to a method performed by an application for communication with a user and a mobile terminal for communicating with a user.

2. Description of the Conventional Art

Interactive voice interface technology is a technology in which a user's voice is input through a microphone (or a mic), and a user's speech intention corresponding to the input voice is understood, thereby providing, in an auditory or tactile manner, the user with an appropriate answer corresponding to a user's question or talk, or providing the user with an appropriate function corresponding to the user's question or talk.

The interactive voice interface technology is provided to various devices, to further improve user's convenience. For example, the interactive voice interface technology may be provided to mobile/portable terminals, stationary terminals, and the like, to improve user's convenience.

Meanwhile, a conventional interactive voice interface merely gives a standardized answer corresponding to a user's question or performs a function corresponding to the user's question, and therefore, it is difficult to exactly understand a user's speech intention.

Accordingly, the development of an interactive voice interface capable of more exactly understanding a user's speed intention has recently been considered.

### SUMMARY OF THE INVENTION

Therefore, an aspect of the detailed description is to provide an application, a method performed by the application, and a mobile terminal, which can provide a more exact answer or function corresponding to a user's speech intention.

Another aspect of the detailed description is to provide an application, a method performed by the application, and a mobile terminal, which can provide a user-customized communication service, in consideration of a user's personality.

Still another aspect of the detailed description is to provide an application, a method performed by the application, and a mobile terminal, which can provide an artificial intelligence communication service capable of understanding user's feelings.

To achieve these and other advantages and in accordance with the purpose of this specification, as embodied and broadly described herein, a method performed by an application for communication with a user installed at a mobile terminal, the method comprising: outputting, via an output unit of the mobile terminal, one or more questions based on a predetermined psychology algorithm; receiving, via a mic of the mobile terminal, one or more verbal answers to the questions from the user; analyzing information related to the verbal answers using the predetermined psychology algorithm; editing a response pattern using the analysis result of the information related to the verbal answers; and outputting, via the output unit of the mobile terminal, if a verbal request of the user is received through the mic of the mobile terminal, one or more responses to the verbal request using the edited response pattern.

In one exemplary embodiment, the questions comprise a first question and a second question. The second question is determined using information related to a first verbal answer to the first question based on the predetermined psychology algorithm.

In one exemplary embodiment, the information related to the first verbal answer is analyzed based on the predetermined psychology algorithm. The second question varies in contents based on the analysis result of the information related to the first verbal answer.

In one exemplary embodiment, a persona is formed by editing the response pattern.

In one exemplary embodiment, the persona is set based on information associated with the user in order to predict user's needs or mindset questions.

In one exemplary embodiment, the response pattern is edited such that the one or more responses to the verbal request are optimized to the user.

In one exemplary embodiment, information related to the one or more responses to the verbal request is collected from one or more external servers connected with a wireless communication unit of the mobile terminal.

In one exemplary embodiment, the one or more external servers comprise Social Network Service SNS server.

In one exemplary embodiment, the information related to the one or more responses to the verbal request is collected using account information of the user from the Social Network Service SNS server.

In one exemplary embodiment, the one or more questions based on the predetermined psychology algorithm is outputted in response to an initial verbal request received via the mic of the mobile terminal. The initial verbal request includes at least one verbal command for operating one or more functions of the mobile terminal.

In one exemplary embodiment, the method is further comprising: determining the one or more functions of the mobile terminal using the response pattern when the initial verbal request is received, and performing, by one or more hardware processors of the mobile terminal, the determined one or more functions.

In one exemplary embodiment, the one or more questions based on the predetermined psychology algorithm is specified by contents of the initial verbal request.

In one exemplary embodiment, the method is further comprising: recognizing a voice of the one or more verbal answers to specify whether the user who told the one or more verbal answers is a first user or a second user.

In one exemplary embodiment, the response pattern comprises a first response pattern and a second response pattern each corresponding to the first user and the second user. If the user who told the one or more verbal answers is the first user, the first response pattern is edited. If the user who told the one or more verbal answers is the second user, the second response pattern is edited.

In one exemplary embodiment, the method is further comprising: recognizing identify whether the user who told the one or more verbal answers is a preset user. The information related to the verbal answers is analyzed only if the user who told the one or more verbal answers is the preset user.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a block diagram illustrating a communication service through an application for communication with a user according to the present disclosure;

FIGS. 2 and 3 are conceptual views illustrating devices to which the application according to the present disclosure can be applied;

FIGS. 4A, 4B, 4C and 4D are block diagrams illustrating a communication service provided through the application according to the present disclosure;

FIG. 5 is a flowchart illustrating a control method according to the present disclosure; and

FIGS. 6A, 6B, 7, 8 and 9 are conceptual views illustrating exemplary embodiments according to the present disclosure.

### DETAILED DESCRIPTION OF EXEMPLARY EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

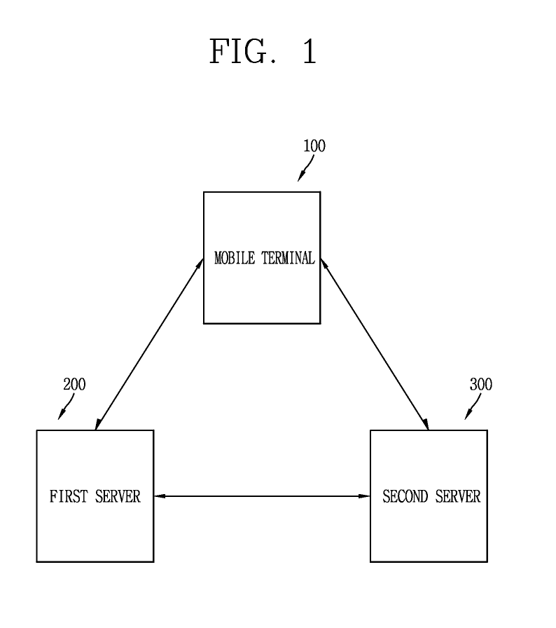

FIG. 1 is a block diagram illustrating a communication service through an application for communication with a user according to the present disclosure.

The application according to the present disclosure may be applied to various devices. For example, as shown in FIG. 1, the application may be applied to a mobile terminal 100.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

Further, although not shown in FIG. 1, the application according to the present disclosure may be applied to a stationary terminal as well as the mobile terminal. Hereinafter, the case where the application is installed at the mobile terminal will be described as an example, but it will be apparent to those skilled in the art that the present disclosure is not limited thereto.

The application according to the present disclosure may be installed at the mobile terminal based on a user's selection, or may exist while being installed at the mobile terminal at the time when the mobile terminal was released. When the application is installed based on the user's selection, the application may be downloaded through an application download server.

Meanwhile, the mobile terminal at which the application according to the present disclosure is installed may communicate with a predetermined external server 200 (hereinafter, referred to as a ‘first server’), to receive, from the first server 200, data for performing a service provided through the application.

Here, the first server 200 may be a server built by a provider for providing the application. The application according to the present disclosure may be controlled by the data received from the first server 200.

Further, the mobile terminal at which the application according to the present disclosure is installed may also communicate with an external server 300 (hereinafter, referred to as a ‘second server’) different from the predetermined external server 200, to receive, from the second server 300, data for performing a service provided through the application.

The data received from the second server 300 may be transmitted based on a request in the application, or may be received based on a request from the first server 200 to the second server 300.

If a specific request is received from the mobile terminal (or the application) at which the application is installed, the first server 200 may transmit answer data corresponding to the specific request, using data stored in the first server 200. Alternatively, if a specific request is received from the mobile terminal (or the application) at which the application is installed, the first server 200 may request the second server 300 of answer data corresponding to the specific request, directly receive the requested data and then transmit the received data to the mobile terminal.

Further, alternatively, if a specific request is received from the mobile terminal (or the application) at which the application is installed, the first server 200 may request the second server 300 of answer data corresponding to the specific request, and directly transmit the requested data from the second server 300 to the mobile terminal 100.

Here, the second server 300 may be one of a plurality of servers, and the plurality of servers may be various kinds of servers accessible through communications. For example, the second server 300 may be a social network service SNS server that provides the SNS. In this state, information connected to a user's account of the application may be obtained from the second server 300. As a specific example, the SNS server may be a server including Facebook, Twitter and the like.

As another example, the second server 300 may be a server corresponding to a knowledge search engine. As a specific example, the server corresponding to the knowledge search engine may be a server corresponding to Google's search engine.

Meanwhile, the application according to the present disclosure receives a voice input from a user, to provide an appropriate answer or function corresponding to the input voice.

Further, the application according to the present disclosure may provide user with information or convenience function, even when there is no request from the user, based on information stored in a device at which the application is installed or information obtained from the second server 300.

Meanwhile, in order to provide a user-customized function more suitable for a user's character, personality and intention, the application according to the present disclosure may analyze the user, using a psychology algorithm.

Here, the psychology algorithm may be based on at least one of the MBTI test, the Saju, the Yin-Yang and the Five Elements, the Enneagram test and other test for psychoanalysis.

According to the application of the present disclosure, i) a question received from the user, ii) a user's answer to a question from the application and iii) information collected in relation to the user may be analyzed using the psychology algorithm, thereby understanding the user's character, personality, intention and the like. As such, according to the present disclosure, the intelligibility for the user is increased, so that more exact information or function can be provided to the user. Further, information or function certainly necessary for the user.

According to the analysis, the application according to the present disclosure may become artificial intelligence.

Hereinafter, examples of devices to which the application according to the present disclosure can be applied will be described, and functions and concepts provided through the application will then be described in detail.

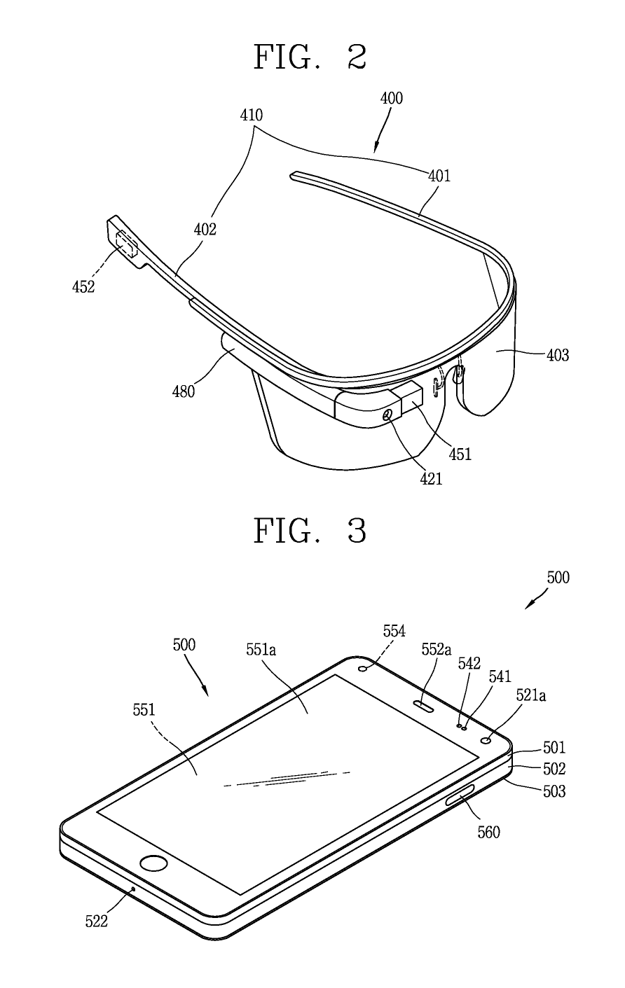

FIGS. 2 and 3 are conceptual views illustrating devices to which the application according to the present disclosure can be applied.

FIG. 2 is a perspective view illustrating one example of a glass-type mobile terminal 400 according to another exemplary embodiment. The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials.

The frame may be supported on the head and defines a space for mounting various components. As illustrated, electronic components, such as a control module 480, an audio output module 452, a sensing unit and the like, may be mounted to the frame part. Also, a lens 403 for covering either or both of the left and right eyes may be detachably coupled to the frame part.

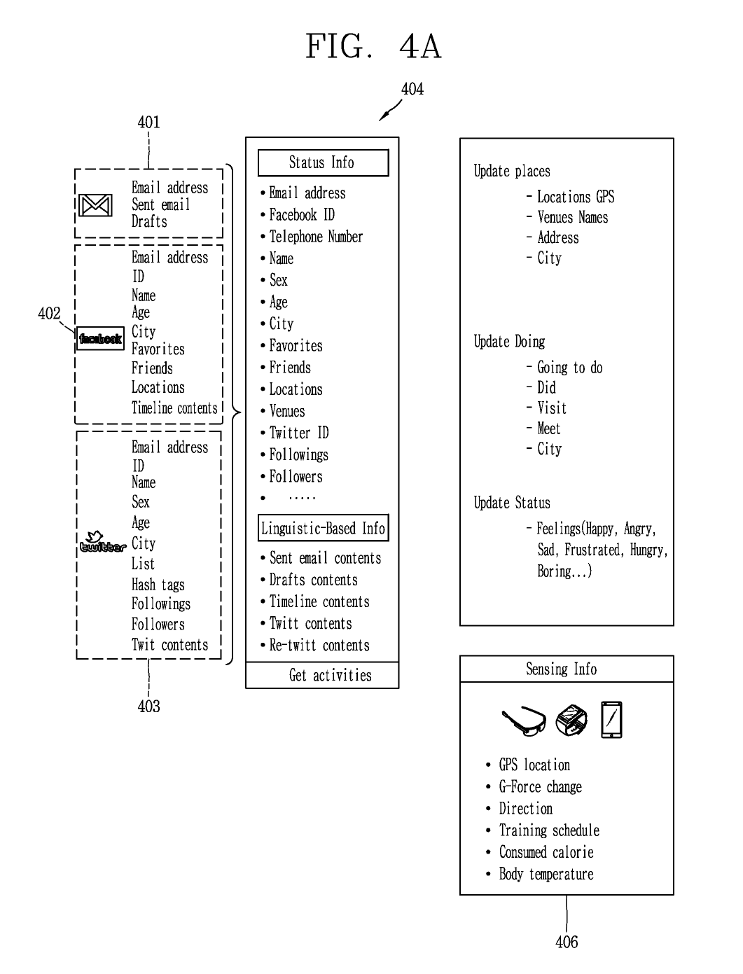

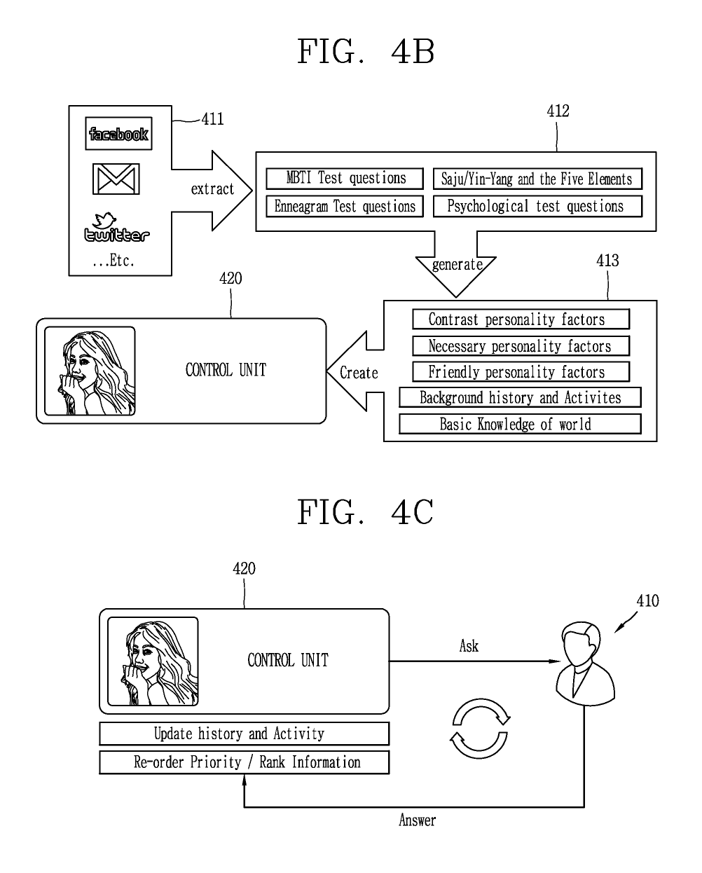

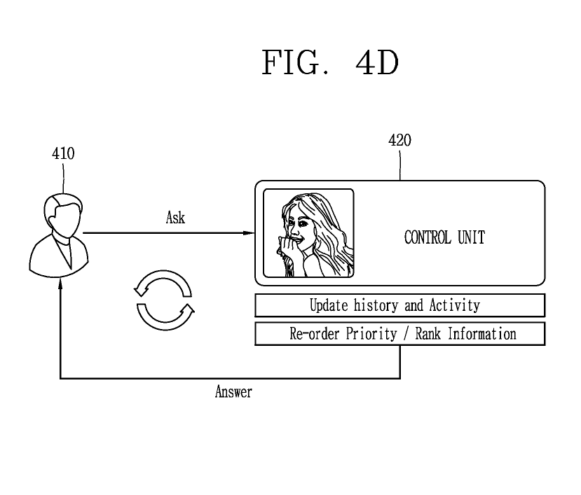

The control module 480 controls various electronic components disposed in the mobile terminal 400. FIG. 4 illustrates that the control module 480 is installed in the frame part on one side of the head, but other locations are possible.

The sensing unit is typically implemented using one or more sensors configured to sense internal information of the mobile terminal, the surrounding environment of the mobile terminal, user information, and the like.

The display unit 451 may be implemented as a head mounted display (HMD). The HMD refers to display techniques by which a display is mounted to a head to show an image directly in front of user's eyes. In order to provide an image directly in front of the user's eyes when the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a realistic image or background using the display.

Further, visual information provided through the application according to the present disclosure, as described above, may be provided through the display unit 451. The visual information may be provided in an AR manner, using characteristics of the display unit 451.

The camera 421 may be located adjacent to either or both of the left and right eyes to capture an image. Since the camera 421 is located adjacent to the eye, the camera 421 can acquire a scene that the user is currently viewing. The camera 421 may be positioned at most any location of the mobile terminal.

If desired, the mobile terminal 400 may include a microphone (or a mic) which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may be closely adhered to the head when the user wears the mobile terminal 400 and vibrate the user's skull to transfer sounds.

Meanwhile, a user's voice is input through the microphone, and the application provides an appropriate function using the voice received through the microphone or analyzes the voice using the psychology algorithm, thereby understanding the user's character, personality, intention and the like.

Meanwhile, the control module 480 provided in the glass-type mobile terminal 400 may be connected to a controller (not shown) corresponding to the application according to the present disclosure, to control components included in the mobile terminal 400 so that functions provided through the application according to the present disclosure can be smoothly performed.

Meanwhile, it will be apparent that the application according to the present disclosure may be applied to a mobile terminal 500 having a type shown in FIG. 3.

The mobile terminal 500 is shown having components such as a wireless communication unit, an input unit, a sensing unit, an output unit, an interface unit, a memory, a controller, and a power supply unit. It is understood that implementing all of the illustrated components is not a requirement, and that greater or fewer components may alternatively be implemented.

The wireless communication unit typically includes one or more modules which permit communications such as wireless communications between the mobile terminal 500 and a wireless communication system, communications between the mobile terminal 500 and another mobile terminal, communications between the mobile terminal 500 and an external server. Further, the wireless communication unit typically includes one or more modules which connect the mobile terminal 500 to one or more networks. To facilitate such communications, the wireless communication unit includes one or more of a broadcast receiving module, a mobile communication module, a wireless Internet module, a short-range communication module, and a location information module.

The input unit includes a camera 521 for obtaining images or video, a microphone 522, which is one type of audio input device for inputting an audio signal, and a user input unit (for example, a touch key, a push key, a mechanical key, a soft key, and the like) for allowing a user to input information. Data (for example, audio, video, image, and the like) is obtained by the input unit and may be analyzed and processed by the controller according to device parameters, user commands, and combinations thereof.

The sensing unit is typically implemented using one or more sensors configured to sense internal information of the mobile terminal, the surrounding environment of the mobile terminal, user information, and the like.

For example, the sensing unit is shown having a proximity sensor 541 and an illumination sensor 542.

If desired, the sensing unit may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 521), a microphone (or a mic) 522, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 500 may be configured to utilize information obtained from sensing unit, and in particular, information obtained from one or more sensors of the sensing unit, and combinations thereof.

Meanwhile, a user's voice is input through the microphone, and the application provides an appropriate function using the voice received through the microphone or analyzes the voice using the psychology algorithm, thereby understanding the user's character, personality, intention and the like.

The output unit is typically configured to output various types of information, such as audio, video, tactile output, and the like. The output unit is shown having a display unit 551, an audio output module 552, a haptic module 153, and an optical output module 554.

The display unit 551 may have an inter-layered structure or an integrated structure with a touch sensor in order to facilitate a touch screen. The touch screen may provide an output interface between the mobile terminal 100 and a user, as well as function as the user input unit which provides an input interface between the mobile terminal 100 and the user.

The controller typically functions to control overall operation of the mobile terminal 500, in addition to the operations associated with the application programs. The controller may provide or process information or functions appropriate for a user by processing signals, data, information and the like.

Meanwhile, in addition to the mobile terminals described in FIGS. 2 and 3, the application according to the present disclosure may be installed at various types of mobile terminals or stationary terminals, to provide a communication service with a user.

Hereinafter, the function and concept of the application for providing the function of a communication service with a user according to the present disclosure will be described in detail. FIGS. 4A, 4B, 4C and 4D are block diagrams illustrating a communication service provided through the application according to the present disclosure.

As described above, in order to provide a user-customized function more suitable for a user's character, personality and intention in communication with the user, the application for providing the function of the communication service according to the present disclosure may analyze the user, using a psychology algorithm.

Here, the psychology algorithm may be based on at least one of the MBTI test, the Four Pillars, the male and female principles, the Enneagram test and other test for psychoanalysis.

According to the application of the present disclosure, i) a question received from the user, ii) a user's answer to a question from the application and iii) information collected in relation to the user may be analyzed using the psychology algorithm, thereby understanding the user's character, personality, intention and the like.

The information collected in relation to the user includes at least one of information stored in a device at which the application is installed, use information related to the device at which the application is installed, sensing information collected from a sensor of the device at which the application is installed, information collected from at least one application different from the application, information accessible through the user's SNS account (or user's account) information, and information that can be obtained from at least one external server, in relation to the user.

Here, the user's account may be a user's account of at least one application, web server, website, or the like. More specifically, the user's account may be a user's ID, an e-mail address, a personal homepage (or website (URL)), or the like. The user's account may be log-in information.

As an example, when information 401 related to an e-mail service is collected, e-mail addresses, sent e-mails, drafts of e-mails, and the like may be collected. The information may be collected from each server of a plurality of e-mail services of which e-mail accounts are possessed by the user. Furthermore, the e-mail accounts may be created by SNS services.

As another example, information may be collected from SNS related to the user. The information may be collected from each server of a plurality of SNS services of which accounts are possessed by the user. More specifically, at least one of e-mail address, user ID, name, age, city, favorites, friends, location and timeline contents may be collected from a first SNS service 402. Also, at least one of e-mail address, user ID, name, sex, age, city, list, hash tags, followings, followers and twit contents may be collected from a second SNS service 403.

As still another example, when the information are collected from a device at which the application is installed, status information may be collected from the device. The status information may be information collected from the e-mail service and the SNS services to the device at which the application is installed.

More specifically, the status information may include at least one of e-mail address, user IDs of SNS services, telephone number, information related to the SNS services (e.g., the above information of the first SNS service 402 and the second SNS service 403).

Also, linguistic-based information (or persona-based information) may be collected from the device. In this case, the linguistic-based information may be collected through postings. Therefore, the linguistic-based information may include at least one of sent e-mail contents, drafts contents, timeline contents, twit contents, and re-twit contents. Meanwhile, other information may be formed based on the collected information. The other information may be formed by the application according to the present disclosure, or may be formed by another application.

As an example, places, doing, status and the like may be updated using the linguistic-based information. The updated places, for example, may become location GPS, Venus names, address, city, etc. The updated doing, for example, may become going to do, did, visit, meet, city, etc. The updated status may become feelings (happy, sad, frustrated, hungry, boring, etc.).

Also, sensing information 406 collected from the sensor of the device at which the application is installed may be used for the purpose of the update. The sensing information may include GPS location, G-force change, direction, training schedule, consumed calorie, body temperature, and the like.

All or some of the above-mentioned information are collected to identify a user's personality. The application according to the present disclosure analyzes the user's personality, using at least some of the above mentioned information. The analysis is performed based on psychology. Specifically, the user's personality may be understood by analyzing the collected information using a psychology algorithm, e.g., a persona method. More specifically, a virtual persona is set based on the collected information in order to predict user's needs or mindset questions in specific situation and environment. The application according to the present disclosure understands a user's personality based on motive and reaction, shown by the virtual persona, and provides information suitable for the user's needs. The information suitable for the user's needs is stored as a kind of response pattern in a device at which the application is installed or a server connected to the application. The response pattern suitable for the user's needs is implemented based on the analyzed user's personality.

Information on which answer is to be given when the user told a word or information corresponding to user's current needs is contained in the response pattern. The response pattern may be stored in a device at which the application is installed, e.g., at least one of a memory of the mobile terminal and a server connected to the application.

In this case, a controller of the application may be configured to provide or search information in a constructed database DB, using the response pattern. Here, the constructed DB may be a database having the stored information connected to the user, through the information collection described above.

Referring to FIG. 4B, the controller of the application of the application provides information suitable for the user's personality, using a response pattern set based on collected information 411.

More specifically, information is analyzed based on the psychology, using the collected information, and the analysis result is classified into a plurality of categories where the user's character and personality can be understood. Accordingly, the application forms the response pattern and provides information to the user.

As shown in FIG. 4B, the response pattern may be understood based on at least one predetermined factor. To this end, the collected information 411 may be extracted as responses to questions 412 of a previously studied test. The questions 412 of the test may include MBTI test questions, Saju/Yin-Yang and the Five Elements, Enneagram Test questions, Psychological test questions, and the like. Next, various kinds of factors are set using the collected information 411 and the questions 412 of the test. The factors may be set based on at least one predetermined category.

As an example, the factors may include at least one of contrast personality factors, necessary personality factors, friendly personality factors, background history and activities, basic knowledge of world, etc.

The user's needs may be understood based on the factors. To this end, the application creates an application's persona based on the factors. That is, the application may form a virtual human or a personality, based on the collected information and the analyzed information. The application's persona allows a device at which the application is installed to operate as if the device had artificial intelligence.

In this case, priority order information may be included in the response pattern. The application's persona detects information of which the user makes much, and provides the information to the user first of all, based on the priority order information. A priority order may be given to each information.

Actually, the application's persona may be databased as a response pattern to user's needs to be stored in a device at which the application is installed or a server connected to the application. More specifically, the response pattern may be formed by the controller included in the application, or may be formed by the server connected to the application. In the present disclosure, the description is under the assumption that the controller is installed in the application, but the present disclosure is not limited thereto. For example, the controller may be provided, separately from the application, in a server or the like connected to the application. The application functions to relay between the server and the device.

According to the present disclosure, as shown in FIGS. 4C and 4D, if the response pattern is formed, the application may output a question based on the response pattern. If the user answers about the question, the application may update the response pattern by analyzing the answer. In this case, the user may recognize that the application's persona communicates with the user.

Meanwhile, the question may be output as audios or characters from the device at which the application is installed, based on the response pattern.

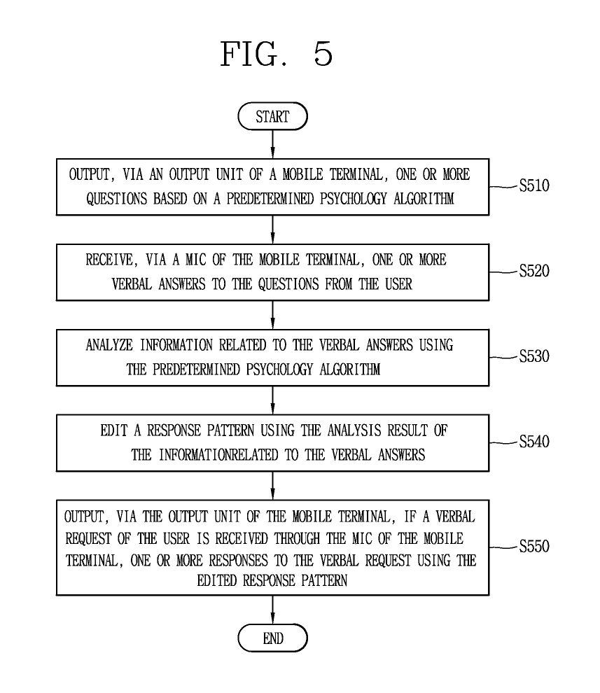

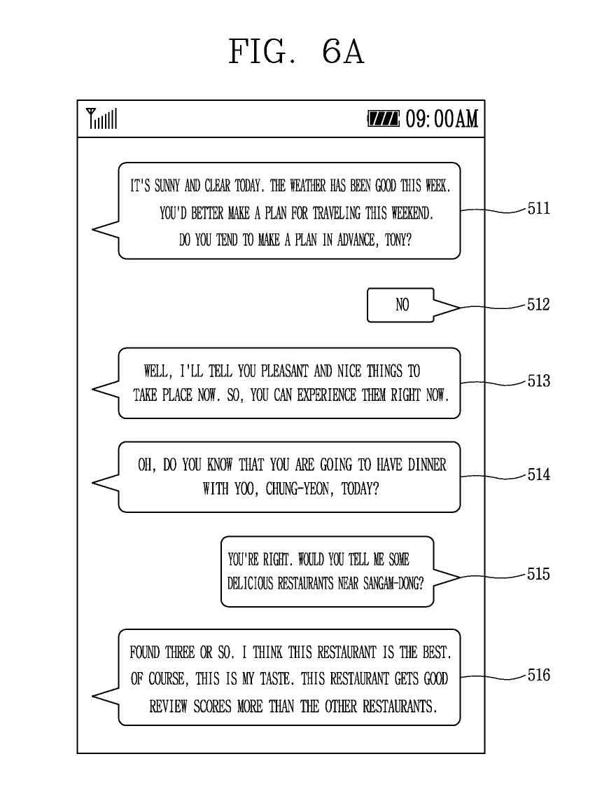

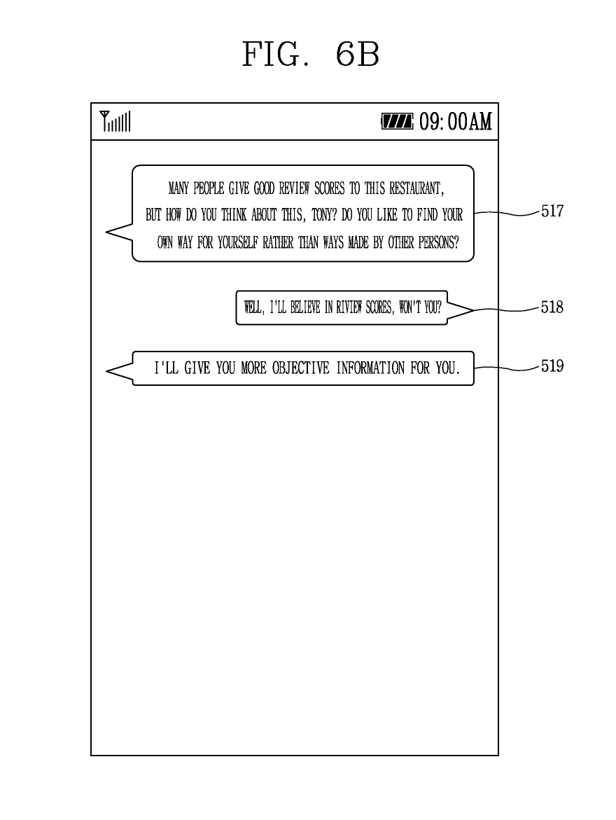

Hereinafter, based on the contents described above, a process of forming a response pattern will be described in detail with reference to the accompanying drawings. FIG. 5 is a flowchart illustrating a control method according to the present disclosure. FIGS. 6A and 6B are conceptual views illustrating the control method described in FIG. 5.

The following descriptions are for the purpose of illustrating a process of outputting a question to a user and forming and updating a response pattern using an answer to the question. Accordingly, the detailed description with respect to the process of forming and updating the response pattern by collecting and analyzing the information related to the user, described above, will be omitted below.

First, according to the application of the present disclosure, at least one question is output to a user, using a psychology algorithm (S510).

The question may be output at an arbitrary point of time by the controller of the application. Alternatively, the question may be output in a state in which the application is being executed.

The execution of the application may be made by a user's request.

For example, when the user files a request for execution of a specific function by inputting a voice to a mic, the controller may perform a function for the user's request and further output a question for analyzing the user.

If the question is output as described above, an answer to the question is then received (S520). The answer to the question may be received through a mic provided in the device at which the application is installed.

Alternatively, the answer to the question may be received through another user input unit (e.g., a touch screen, keyboard, mouse or the like) as well as the mic provided in the device at which the application is installed.

If the answer to the question is received as described above, the answer is analyzed using the psychology algorithm (S530).

Here, when the answer is received as a voice, the voice answer is converted into a text, based on STT (Speech to Text). The controller analyzes information converted into the text, i.e., information related to the answer.

If the answer to the question is analyzed, the controller may output another question, using the analysis result, and analyze an answer to the output question.

As such, processes of outputting a question and analyzing an answer to the question may be repeatedly performed.

One or more questions include a first question and a second question, and the second question is determined using information related to a first verbal answer to the first question and the predetermined psychology algorithm.

The may determine the second question, based on a user's verbal answer to the first question. That is, the contents of the second question may be changed based on the user's verbal answer to the first question.

Further, when a question is output corresponding to a verbal request of the user the controller may output a question with contents related to the user's request.

The controller may output a question where the user's mental state can be analyzed while being proper in a current situation, using the psychology algorithm.

If the analysis is completed, a response pattern is edited using the analysis result (540). The response pattern to be edited may be a response pattern previously formed in relation to the user that answered. When any response pattern specified to a specific user does not exist, a basic response pattern basically provided in the application may be the response pattern to be edited.

Meanwhile, the controller of the application according to the present disclosure may edit the response pattern related to the user that answered by recognizing the user.

Here, the edition of the response pattern is the same concept as the update of the response pattern. According to the present disclosure, the edition of the response pattern is performed using the analysis result, so that the user's preference, personality, character and the like can be understood much better.

In this case, the controller may use the response pattern related to the recognized user even in the process of outputting the question, described above.

Meanwhile, the recognition of the user may be performed in various manners. As an example, the recognition of the user may be performed by analyzing a user's voice. As another example, the recognition of the user may be performed by analyzing the user's face in an image received through a camera. As still another example, it will be apparent that the recognition of the user may be performed through fingerprint recognition.

If a specific user is recognized as described above, user-customized information may be provided to the recognized user, using a response pattern related to the recognized user.

Meanwhile, if a verbal request of the user is received after the response pattern is edited as described above, the controller outputs at least one appropriate response to the verbal request of the user (S550).

The controller may output the response based on information stored in the memory, and otherwise, may output the response using information stored in an external DB accessible through communication.

Here, the external DB, as described above, may exist in the SNS server.

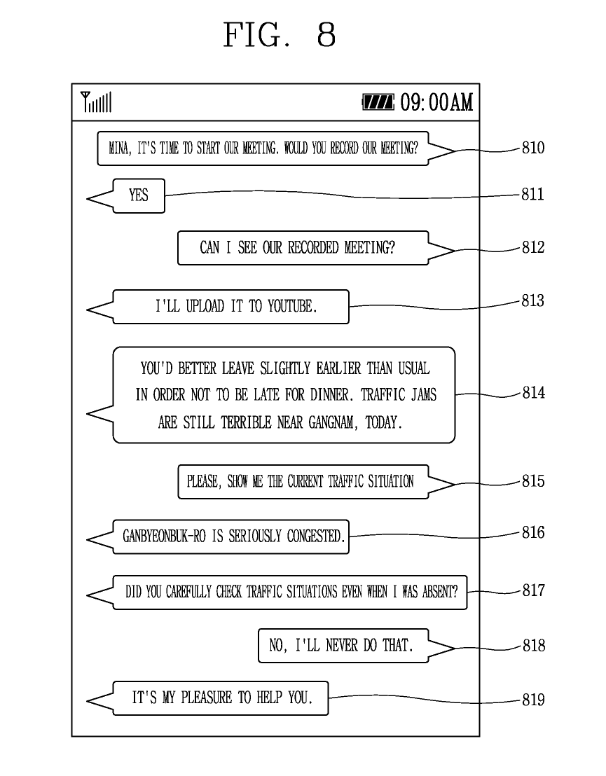

Hereinafter, a method for performing and analyzing a question based on the psychology will be described in detail, through an example in which a virtual persona formed by the application according to the present disclosure communicates with a user. FIGS. 6A, 6B, 7, 8 and 9 are conceptual views illustrating exemplary embodiments according to the present disclosure.

First, referring to FIG. 6A, a virtual persona formed by the application according to the present disclosure may understand a user's personality through a question “Do you tend to make a plan in advance?” (the question that the virtual persona asks is controlled by the controller).

Further, when the user answers “No” as a response to the question, the virtual persona may analyze the response and answer to provide current information as the result of the analysis.

As shown in FIG. 6A, in addition to the function of outputting a question to the user, answering to a user's question and responding to the user's question, the application according to the present disclosure performs, like a user's secretary, a function of checking user's schedule and notifying the user of the checked schedule, and the like.

For example, the virtual persona may notify the user of schedule, using information on schedule stored in relation to a schedule application.

As shown in FIGS. 6A and 6B, after an answer corresponding to a user's request is performed, a question for analyzing the user's personality may be again output. In this state, the question for analyzing the user's personality may be composed of contents related to the user's request.

For example, when the user requests to search for delicious restaurants, searched restaurants are output, and information that the user can naturally receive in relation to the searched restaurants may be output. The controller may analyze a user's answer to the related question, and edit or update a response pattern to the users answer.

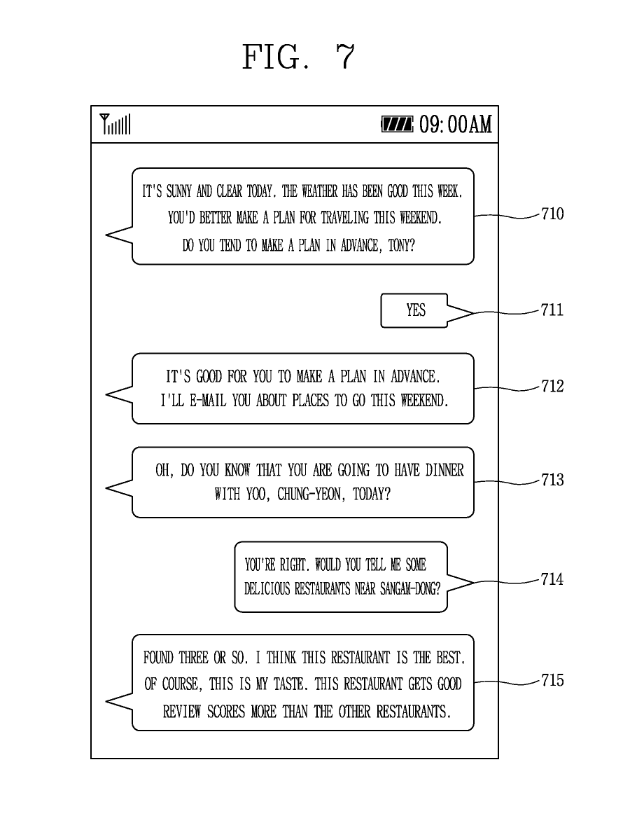

Meanwhile, as described above, the contents of the question may be changed depending on a user's answer. In FIG. 6A, when the user answers “No” to the question whether the user makes the plan in advance, the controller has obtained an analysis result of providing information on current situations. However, as shown in FIG. 7, when the user answers “Yes” to the question, the controller may obtain an analysis result that information should be provided so that the user can make a plan in advance.

The application according to the present disclosure may operate in connection to components of the device at which the application is installed, so that a function corresponding to the user's request is performed. The connection may be performed as a controller of the device and the controller of the application exchange information with each other.

For example, the user may request a specific operation of the device to be performed, using the application. In this case, the user may request an image to be recorded, and the controller of the application may request the controller of the device to control a camera or directly control the camera so that the image is recorded.

The controller of the application uploads the recorded image to a specific server, using previously stored user account information, thereby improving user convenience.

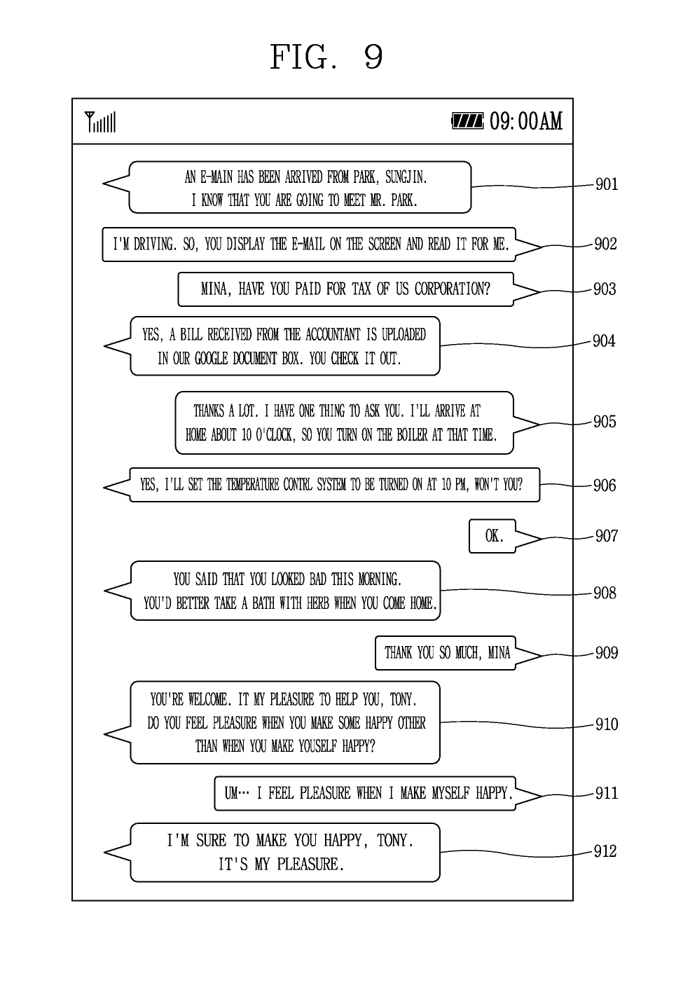

As shown in FIG. 9, the application according to the present disclosure may also control devices included in a home network through communication with a home network server. For example, if the user request a boiler to operate, the controller may directly transmit an operation command to the boiler, or may allow the operation command to be transmitted to the boiler through the home network server.

As described above, according to the application of the present disclosure, it is possible to implement an artificial intelligence communication service that can provide a user-customized communication service, in consideration of a user's personality.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method performed by an application for communication with a user installed at a mobile terminal, the method comprising:
outputting, via an output unit of the mobile terminal, one or more questions based on a predetermined psychology algorithm;
receiving, via a mic of the mobile terminal, one or more verbal answers to the questions from the user;
analyzing information related to the verbal answers using the predetermined psychology algorithm;
editing a response pattern using the analysis result of the information related to the verbal answers; and
outputting, via the output unit of the mobile terminal, if a verbal request of the user is received through the mic of the mobile terminal, one or more responses to the verbal request using the edited response pattern.

2. The method of claim 1, wherein the questions comprise a first question and a second question,
wherein the second question is determined using information related to a first verbal answer to the first question based on the predetermined psychology algorithm.

3. The method of claim 2, wherein the information related to the first verbal answer is analyzed based on the predetermined psychology algorithm, and
wherein the second question varies in contents based on the analysis result of the information related to the first verbal answer.

4. The method of claim 3, wherein a persona is formed by editing the response pattern.

5. The method of claim 1, wherein the persona is set based on information associated with the user in order to predict user's needs or mindset questions.

6. The method of claim 1, wherein the response pattern is edited such that the one or more responses to the verbal request are optimized to the user.

7. The method of claim 1, wherein information related to the one or more responses to the verbal request is collected from one or more external servers connected with a wireless communication unit of the mobile terminal.

8. The method of claim 7, wherein the one or more external servers comprise Social Network Service SNS server.

9. The method of claim 8, wherein the information related to the one or more responses to the verbal request is collected using account information of the user from the SNS server.

10. The method of claim 1, wherein the one or more questions based on the predetermined psychology algorithm is outputted in response to an initial verbal request received via the mic of the mobile terminal, and
wherein the initial verbal request includes at least one verbal command for operating one or more functions of the mobile terminal.

11. The method of claim 10, further comprising:
determining the one or more functions of the mobile terminal using the response pattern when the initial verbal request is received, and
performing, by one or more hardware processors of the mobile terminal, the determined one or more functions.

12. The method of claim 10, wherein the one or more questions based on the predetermined psychology algorithm is specified by contents of the initial verbal request.

13. The method of claim 1, further comprising:
recognizing a voice of the one or more verbal answers to specify whether the user who told the one or more verbal answers is a first user or a second user.

14. The method of claim 13, wherein the response pattern comprises a first response pattern and a second response pattern each corresponding to the first user and the second user,
wherein if the user who told the one or more verbal answers is the first user, the first response pattern is edited, and
wherein if the user who told the one or more verbal answers is the second user, the second response pattern is edited.

15. The method of claim 1, further comprising:
identify whether the user who told the one or more verbal answers is a preset user, wherein the information related to the verbal answers is analyzed only if the user who told the one or more verbal answers is the preset user.
